(19) United States
(12) Patent Application Publication
(10) Pub. No.: US 2002/0188460 A1
(43) Pub. Date: Dec. 12, 2002

(54) System and method for interactive research

(76) Inventor: Owen E. Resh, Pleasant Ridge, MI (US)

Correspondence Address: MATTHEW R. MOWERS, Brooks & Kushman P.C., 22nd Floor, 1000 Town Center, Southfield, MI, 48075-1351, US

(21) Appl. No.: 10/097,970

(22) Filed: Mar. 14, 2002

Related U.S. Application Data
(60) Provisional application No. 60/275,824, filed on Mar. 14, 2001.

(51) Int. Cl. G06F 17/60

(52) U.S. Cl. 705/1

(57) ABSTRACT

Methods and systems for interactive market research according to the present invention provide structured market research using a framework that responds to the dynamic of a research event by redirecting resources and modifying stimuli during the event based on participant feedback to outpace and constructively redirect the dynamic of the event. The systems and methods provide a structured inquiry using a central linear model capable of invoking alternate graphic investigations supporting the goal of product optimization. Unique inquiries are provided along a central path using core stimuli, such as different themes, in addition to inquiries along parallel paths using satellite stimuli relative to appearance, content, or concept within the overall structure.

### CROSS-REFERENCE TO RELATED APPLICATION

This application claims priority to U.S. provisional patent application Ser. No. 60/275,824, titled “System and Method for Interactive Research” filed Mar. 14, 2001, the disclosure of which is hereby incorporated by reference in its entirety.

### BACKGROUND OF THE INVENTION

1. Field of the Invention

The present invention relates to a system and method for interactive market research using participant feedback to modify computer generated stimuli during a research event.

2. Background Art

Product development typically requires some customer or market research to provide a measure of the likelihood of success of the ultimate product. Less expensive market research strategies may include customer surveys or interviews. However, the results obtained are often of limited value. New or modified products that require a large investment to bring them to market warrant correspondingly more market research to avoid manufacturing a product that results in a poor (or negative) return on investment. More comprehensive market research may involve multiple research events, such as clinics or focus groups, for example, which may span several hours or several days. Feedback from these research events is then compiled and may be used to modify a proposed or existing product. The modified product may then be used in a subsequent research event to determine the impact of any modifications. Multiple iterations of research events and design changes may be necessary to refine various aspects of a product, particularly a complex product, such as an automobile, for example. In addition to the significant cost associated with multiple iterations, time-to-market is extended leaving the producer more vulnerable to competitive products or changes in market conditions.

A number of techniques have been developed for interactive market research events. Participants are typically selected based on target market demographics and invited to attend the event. During the event, a moderator presents previously prepared stimuli, such as alternative product designs, to the participants and collects feedback. The prepared stimuli may be presented in various formats including a written and/or verbal description, or using various combinations of audio/visual technology to balance the cost and time necessary to generate the stimuli with the anticipated benefit of the information collected from the participants. Presentation of primary or main themes is typically more refined than the presentation of secondary themes or minor modifications. For example, a video or animation may be used to present primary themes while sketches, storyboards, still photographs, or a written description may be used to present product variations that the researcher believes are less important to the ultimate product design.

Sophisticated computer graphics have enabled computer generated or digital prototypes that offer many advantages for use as stimuli during a research event, particularly for complex products for which prototypes are costly. Originally, digital prototypes were limited to two-dimensional slides or still pictures. This evolved to videotaped animations that provided analysis of space and mass, although in a media format of limited potential. Animated illustration directly from a digital database raised the quality level of stimuli and introduced a modest interactive element. While the methods of presenting stimuli during a research event have taken advantage of the more sophisticated computer technology to provide some level of interactivity, the underlying research process has not fundamentally changed and still requires multiple iterations of product redesign and research.

Regardless of the method used to present alternatives during a conventional research event, a pattern of response or dynamic generally emerges relative to the stimuli selected for presentation to the participants. The present invention recognizes that if the stimuli do not change, the dynamic or pattern of response will remain predictable and continue throughout the remainder of the event, reducing the overall value of the event.

### SUMMARY OF THE INVENTION

Methods and systems for interactive market research according to the present invention provide structured market research using a framework that responds to the dynamic of a research event by redirecting resources and modifying stimuli during the event based on participant feedback to outpace and constructively redirect the dynamic of the event. The systems and methods provide a structured inquiry using a central linear model capable of invoking alternate graphic investigations supporting the goal of product optimization. Unique inquiries are provided along a central path using core stimuli, such as different themes, in addition to inquiries along parallel paths using satellite stimuli relative to appearance, content, or concept within the overall structure. The inquiries may be incorporated into a relative value study, a content/concept study, a minor modifications study, 180 degree study and/or a funnel study, for example. The parallel paths facilitate the discovery of the best execution of a particular theme based upon features provided by the studio, brand, and customer within a compressed time frame. A relative value study enables an investigation of three-dimensional spacial features by prioritizing the value of component space. A funnel study enables an investigation to determine how a successful product may become less successful when returned to an internal development process. This provides boundaries for further product development by the client/manufacturer.

The present invention provides a number of advantages. For example, the present invention enables the user to perform an investigation to determine the marketability of a product and improve the product within the same event timeline using customer feedback to increase subsequent marketability. Systems and methods according to the present invention provide interactive means f for determining how to improve an object or product based on target customer feedback as compared to prior approaches that only determined what aspect or feature of a product needed improvement and had no means for integrating a customer driven solution within the same research event.

The interactive system and process of the present invention, unlike previous approaches to market research, generate a deliverable in the form of digital graphic images (such as a high resolution picture) rather than text. Each research event will result in the creation of original images of original customer driven objects that are stored in a database, which will grow with each successive research event. These images summarize the refinement and/or optimization of the object and are a valuable tool for subsequent use by designers to make appropriate changes to an object or product. The database may be remotely accessible throughout the research event to enable direct input of unique or modified stimuli from a design studio, client, or marketing firm, for example. As a deliverable after the research event, the database may eventually enable the client to run simulations prior to a subsequent research event to pre-screen design concepts.

The present invention increases the research value, deliverable value, and customer participation of a research event to optimize design themes during a compressed time-to-market cycle by using central and parallel studies incorporating visualization technology to provide computer generated graphic images to create a real-time three-dimensional virtual reality environment. This allows viewing a theme from any direction and in alternative environments to expand the interactivity of the event. In addition, computer generated or digital stimuli moves seamlessly between multiple research venues and formats that may include traditional focus groups, kiosks, or use of the internet, for example.

The present invention provides a method and associated system that use high resolution computer generated images to facilitate an interactive dialog between designers, researchers, and respondents. This enables the invention to redirect the dynamic of a research event such that more productive results are obtained. Increasing productivity of a research event may reduce the number of events necessary thereby reducing the associated costs and overall time required in a typical product development cycle leading to a reduced time to market. The central and parallel paths of a research event according to the present invention improve the quality of the research data delivered to design teams, while also allowing the client to retain design authority so that any product modifications are consistent with business and marketing goals. In addition, the central and parallel paths enable research relative to various product/process and/or environmental alternatives without isolation such that the interaction between multiple design factors is captured.

The present invention enables comprehensive research within a compressed product development cycle that can be used to confirm product line objectives (rejuvenation as compared to a new niche) while maintaining integrity of a desired theme and discovering the best execution of that theme.

The above advantages and other objects, features and advantages of the present invention are readily apparent from the following detailed description of the best mode for carrying out the invention when taken in connection with the accompanying drawings.

### BRIEF DESCRIPTION OF THE DRAWINGS

FIG. 1 is a perspective view of one embodiment of an interactive research system and method according to the present invention;

FIG. 2 is a graph illustrating data recovery using a traditional research event with static stimuli;

FIG. 3 is a graph illustrating data recovery using a system or method for interactive research with dynamic stimuli according to one embodiment of the present invention;

FIG. 4 is a diagram illustrating an adaptation of the Ansoff product research model for use in a system or method of interactive market research according to the present invention;

FIG. 5 is a graphical illustration of a research process model representing one embodiment of a system or method for interactive research according to the present invention;

FIG. 6 is a graphical representation of a research process model showing one possible research event dynamic corresponding to an emerging leader during an interactive research event with deployable resources and dynamic stimuli according to one embodiment of the present invention;

FIG. 7 is a graphical representation of a research process model showing another possible research event dynamic corresponding to no apparent product leader during an interactive research event according to one embodiment of the present invention;

FIG. 8 is a graphical representation of a research process model showing a third possible research event dynamic corresponding to the benchmark as product leader during an interactive research event according to one embodiment of the present invention;

FIG. 9 is a graphical representation of a funnel study that can be conducted to investigate satellite stimuli in parallel with the core stimuli embodying the main themes of a research event according to one embodiment of the present invention;

FIGS. 10A-10C are graphical illustrations of a relative value study that can be conducted to investigate the relative importance of various product aspects or features based on feedback from research event participants according to one embodiment of the present invention; and

FIG. 11 is a graphical illustration of a minor modifications study that can be conducted to fine tune a product based on respondent feedback according to one embodiment of the present invention.

### DETAILED DESCRIPTION OF THE PREFERRED EMBODIMENT(S)

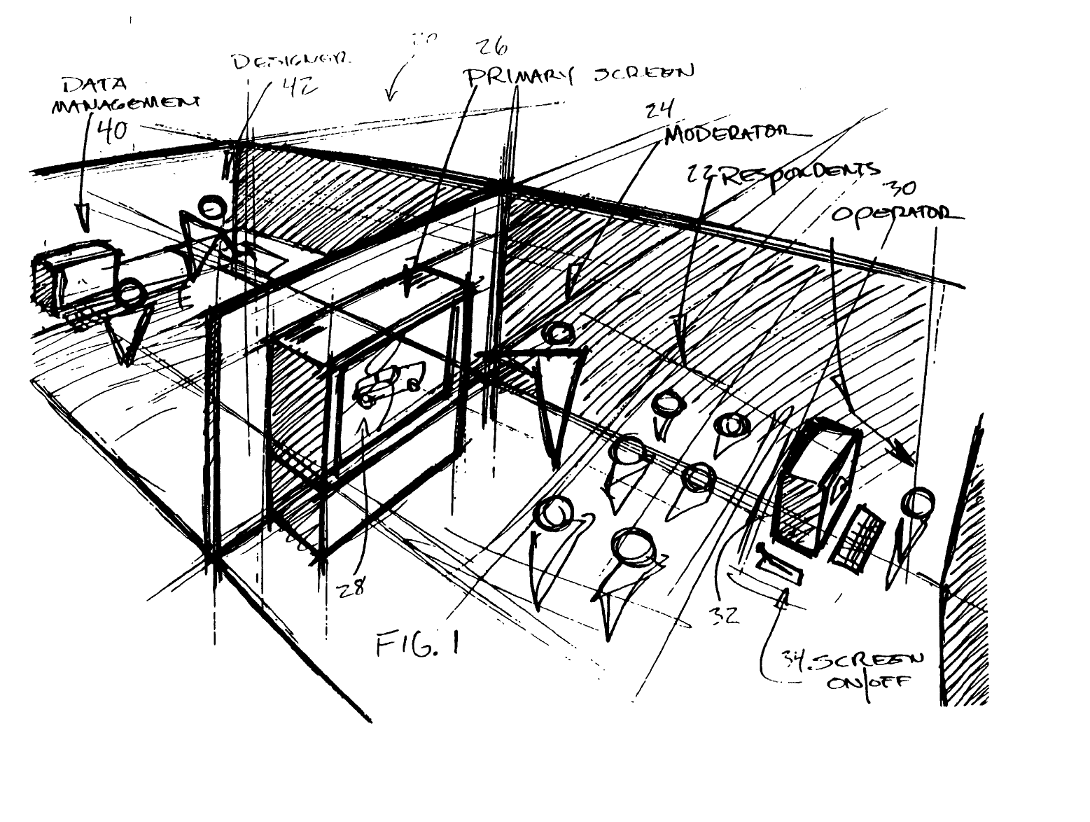

Referring now to FIG. 1, a perspective view of a representative implementation for a system or method for interactive research according to one embodiment of the present invention is shown. As will be appreciated by those of ordinary skill in the art, one of the advantages of the present invention is that systems and methods according to the present invention may be used in a variety of market research venues and formats. FIG. 1 illustrates use of system 20 with a conventional focus group over the course of several days. Other formats that may be used include interactive kiosks or a website accessed by participants using the internet, for example.

Although only one group of respondents 22 is illustrated in FIG. 1, typically several groups of respondents 22 will participate in a research event or clinic. Depending upon the available resources, each group of respondents may participate simultaneously in separate rooms each having a system 20, or may use the same room and system 20 at different times during the event. Such an arrangement facilitates multiple parallel studies supporting a central research strategy as explained in greater detail herein. The number of respondents in each group may vary depending upon the particular type of product research being conducted. In addition to respondents 22, a focus group typically includes a moderator 24 that generally directs the group and is responsible for coordinating presentation of various types of stimuli to respondents 22 and collecting or overseeing collection of feedback in response to the stimuli. In the example illustrated in FIG. 1, a primary screen or monitor 26 is used to present digital stimuli to respondents 22. The digital stimuli according to the present invention include high resolution three-dimensional images 28 and animation developed using a computer from surface data based on a design direction provided by the client developing a particular product. An operator 30 may also be present to operate computer 32 and prepare the digital stimuli for presentation to respondents 22 at appropriate times during the event. Computer 32 may be used to operate a switch 34 that controls display of images 28 on primary screen 26. Computer 32 may also be used to collect feedback from respondents 22. Feedback may be provided via various well known means. For example, operator 30 may manually enter comments or suggestions from respondents 22 associated with particular stimuli or images 28. Respondents 22 may complete written comments or surveys throughout the event or at predetermined times to capture reactions to various digital stimuli. The group may be videotaped or otherwise recorded to capture verbal and non-verbal reactions to various stimuli. Likewise, input devices may be provided to respondents 22 to provide real-time feedback of likes and dislikes relative to the digital stimuli as the digital stimuli is presented. Similarly, respondents 22 may be provided input devices to modify the digital stimuli by changing various aspects or features of a displayed product. Preferably, digital stimuli is modified by one or more designers 42 cooperating with an operator of data management computer 40 based on feedback from respondents 22 with subsequent presentation of the modified digital stimuli on primary screen 26 controlled by operator 30 and/or moderator 24. Designer(s) 42 and data management computer and operator 40 may be located on-site at the event or may be connected to operator computer 30 by a local or wide area network, such as the internet, for example.

In a representative research event according to the present invention, respondents 22 may first be shown two-dimensional illustrations to introduce a design concept. The balance of the inquiry would then be performed using computer generated stimuli in the form of high resolution three-dimensional surface renderings 28 that may include animation. Feedback from respondents 22 is preferably used to modify the digital stimuli by manipulating the computer model to generate new or modified stimuli for subsequent presentation to respondents 22 using primary screen 26.

The use of dynamic stimuli, i.e. stimuli generated or modified in response to feedback from participants, provides more control over the dynamic of the event to expand the scope of the product research leading to a deeper inquiry and more valuable data obtained in a compressed time frame. The dynamic nature of the stimuli can prevent a particular objectionable product feature or aspect from arresting the inquiry. For example, if a primary objective of the research event is to determine the exterior styling of a new convertible vehicle but one or more of the group participants voices concerns over the safety of the design, without the present invention, the value of the research event may be significantly reduced because of the objections raised by the participant(s) that have nothing to do with the original objective, i.e. the exterior styling. However, the present invention provides the ability to react to participant feedback and address such concerns, by adding a roll bar, for example, so that the event can overcome objections and continue to provide valuable information relative to the primary objective. Likewise, participants may suggest alternatives that were not included in the previously prepared stimuli. By generating new or modified stimuli and presenting it during the same research event, the present invention promotes active, on-site investigation of unexpected customer ideas using stimuli having a graphical quality commensurate with the originally presented stimuli. As described in greater detail below, the stimuli presented to the participants may include various core or primary stimuli, in addition to satellite or secondary stimuli. In addition, the product environment may be included within the core or satellite stimuli such that the product can be visualized in one or more purchase environments and one or more functional or use environments.

The original stimuli is preferably stored along with the new and/or modified stimuli in a common graphic database. Respondent feedback may also be stored in the common database or an associated database. The database may be remotely accessible throughout the research event by the client, designers, or other authorized personnel depending upon the particular implementation.

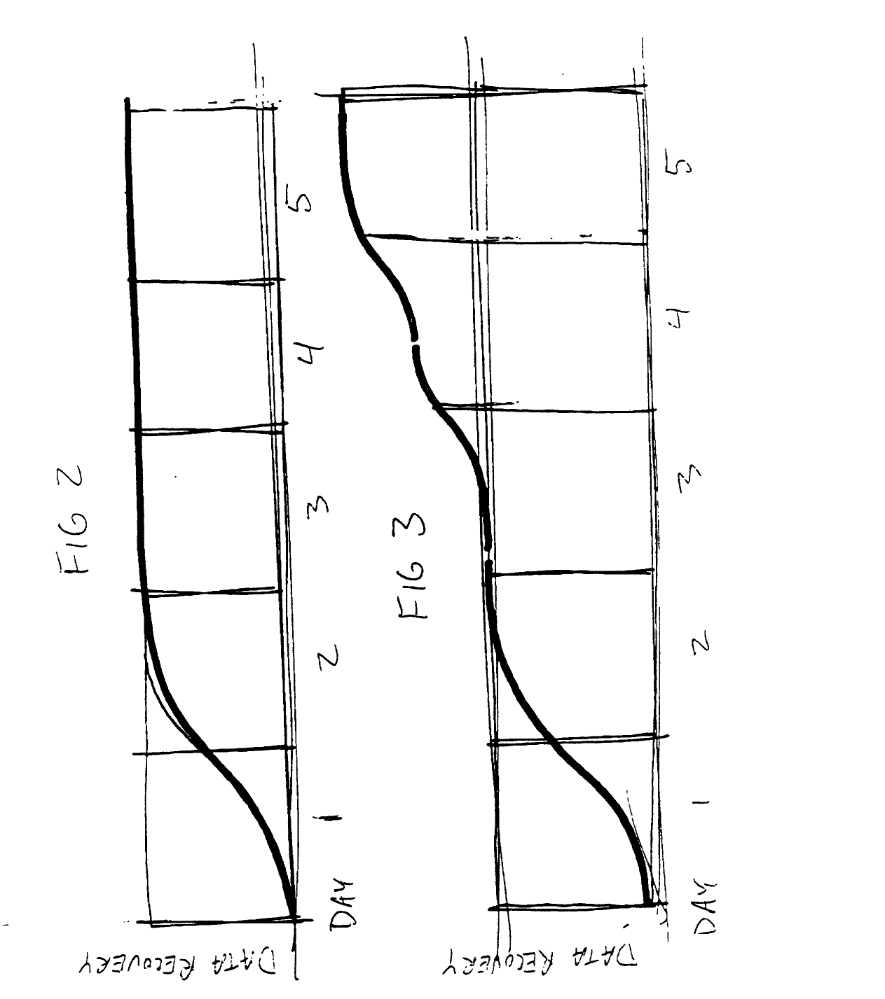

FIG. 2 is a graphic representation of product data recovery during a traditional research event or clinic using previously prepared static stimuli. The graph represents the value of data (participant feedback) obtained or recovered over the course of a five (5) day research event or clinic. The feedback from static stimuli can plateau early as manifested in a pattern of response to subsequent stimuli as illustrated in day two (2) of the graph, for example. This reduces the value of the remainder of the event because the response to subsequent stimuli is predictable. In the convertible vehicle example describe above, once an objection is raised and validated by the participants, the subsequent responses to previously prepared stimuli are devalued because the objectionable feature distorts the response and the data recovery plateaus.

FIG. 3 illustrates data value or recovery for a similar research event or clinic, but using dynamic stimuli according to the present invention. When a pattern of response or event dynamic emerges during day two (2) and the data value plateaus, the original stimuli is modified or replaced by new stimuli presented during day three (3) enabling a deeper inquiry and continuing to recover data useful to the client or customer. This process may be repeated as necessary throughout the event in response to the event dynamic as manifested in the participant feedback. Modification of the stimuli during the event increases the overall research value within a compressed time line while retaining design authority with the client. Generation of new or modified stimuli also increases the value of the deliverable graphic database that can be provided to design or product planning groups as images or animations, for example.

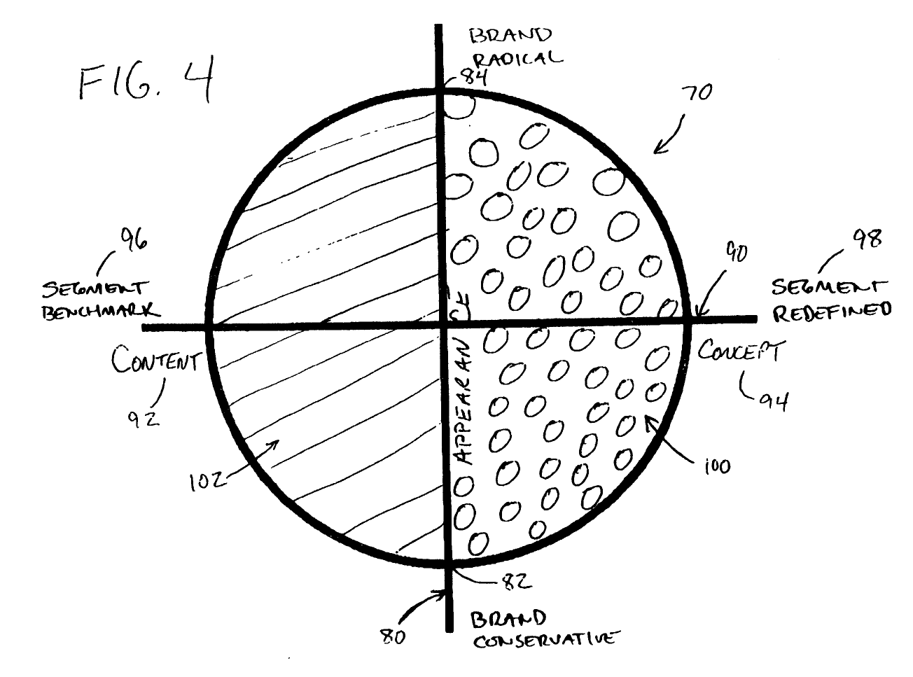

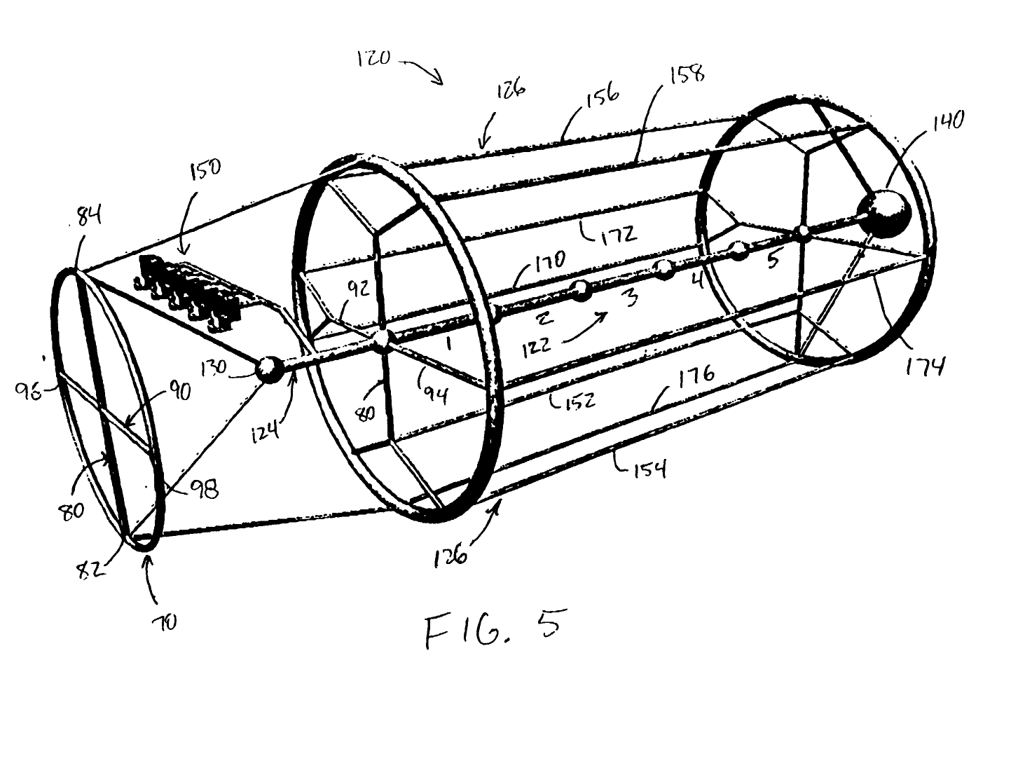

A diagram illustrating an adaptation of the Ansoff product research model for use in a system or method of interactive market research according to the present invention is shown in FIG. 4. This model is useful to characterize the impact of various product features or attributes that contribute to a purchaser's perception of the product and identify whether the product rejuvenation is appropriate to satisfy the consumer or whether a new product concept is required. Vertical axis 80 represents the product appearance as associated with a particular brand with more conservative features or modifications toward end 82 and more radical features or modifications toward end 84. Horizontal axis 90 represents a characterization of modifications to product content 92 as compared to product concept 94. Product features or characteristics may be similar to a product segment benchmark or leader 96 or may indicate a redefinition of the segment as represented by reference numeral 98. A new product concept is indicated for products classified within area 100 with product rejuvenation indicated for products characterized within area 102.

FIG. 5 is a graphical illustration of a research process model representing one embodiment of a system or method for interactive research according to the present invention. Research process model 120 applies the adapted Ansoff research model 70 over the course of a research clinic or event. In the example illustrated in FIG. 5, the research event includes five days 122. Process model 120 includes a central path 124 surrounded by several parallel paths 126. Activity within the central path 124 is based on linear or core stimuli 130 and coordinates the event objectives, maintains the event timing, and determines the need for any detailed inquiry through broader theme research. The parallel research paths 126 investigate various satellite stimuli while supporting central path 124 and creating focused studies of issues generated by primary research or to confirm findings. The results of these studies are accessible to any part of the research event. This enables a series of studies to operate simultaneously, interact with one another, and build a deliverable database 140 within a normal event time table, five days in this example.

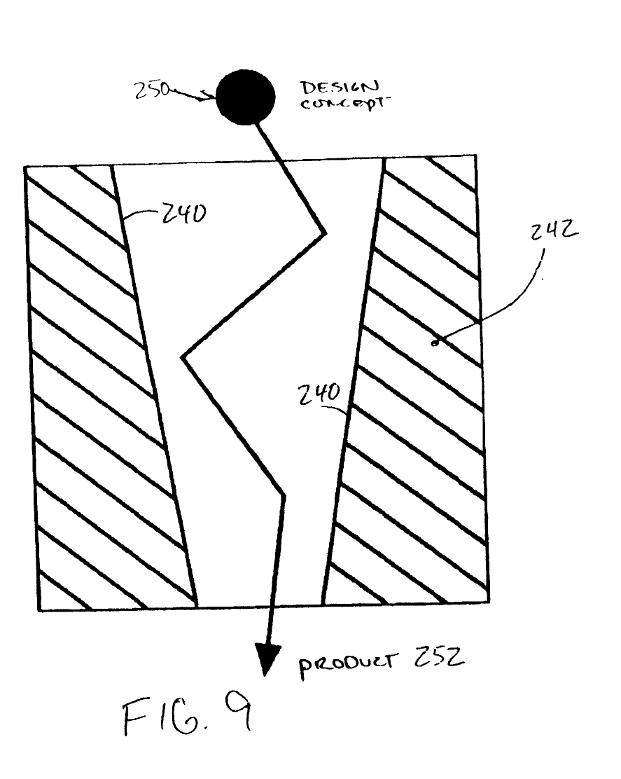

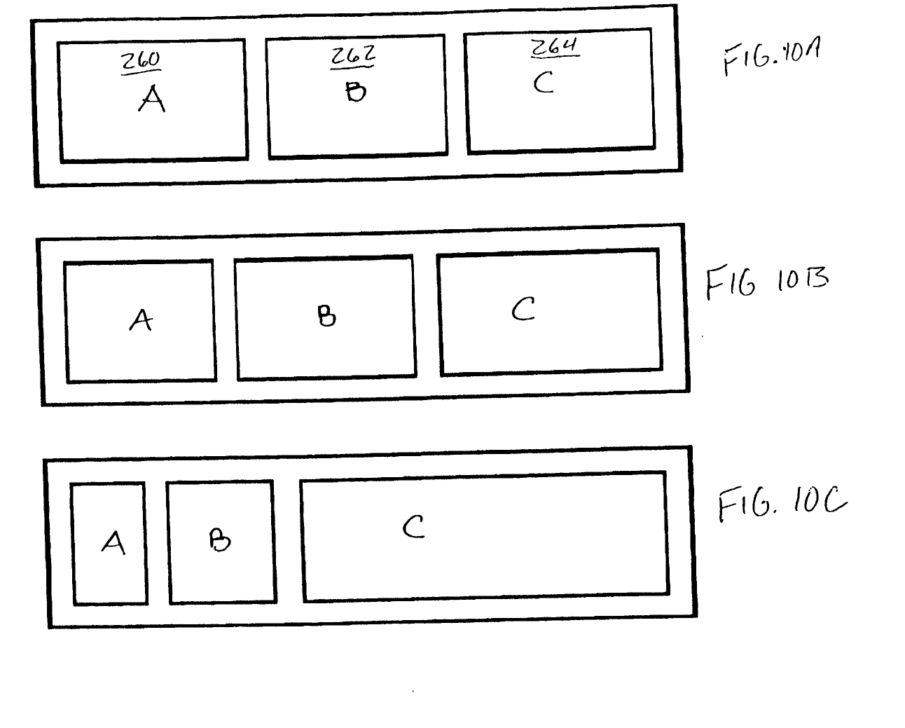

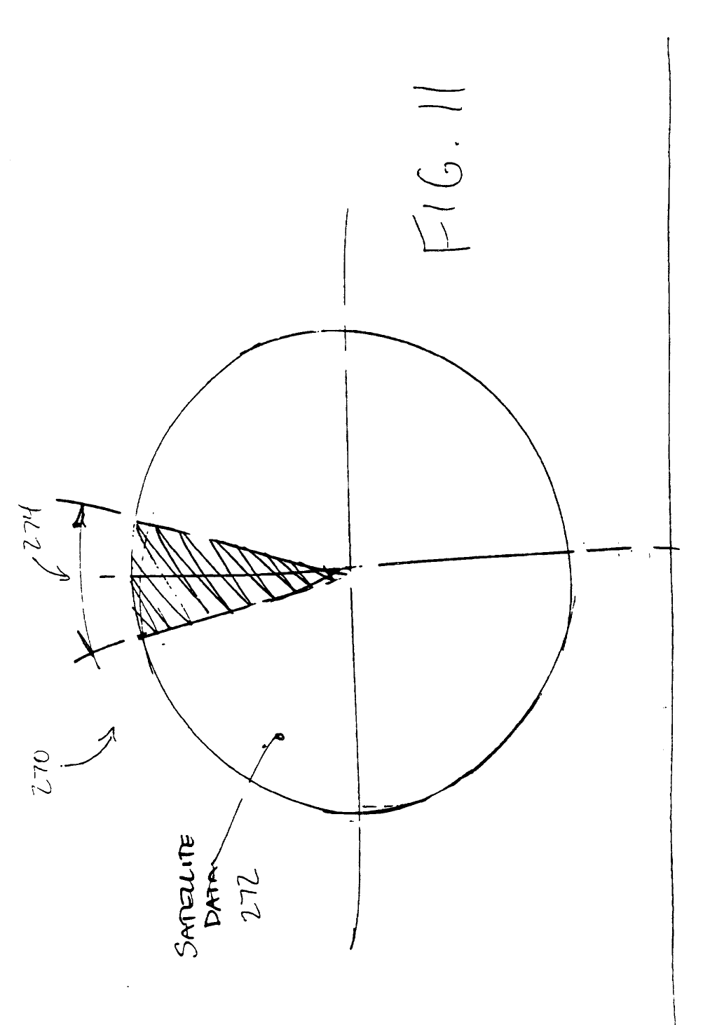

Parallel paths 126 may be used to dynamically allocate deployable onsite resources 150. Deployable resources may vary depending upon the particular venue and research format. In one embodiment, each of deployable resources 150 correspond to a system 20 as illustrated and described with reference to FIG. 1. Deployable resources 150 may be redirected or allocated to focus on issue studies, which may include content studies 92, concept studies 94, and appearance studies 80, for example. Appearance studies 80 may include color/graphics studies 152, materials studies 154, 180 degree studies 156, or minor modifications studies 158, for example. Content studies 92 may include component/feature studies 170 and relative value studies 172, which may be used to determine the relative value of product content, packaging, and customer needs as illustrated and described with reference to FIGS. 10A-10C, for example. Concept studies 94 may include an interactive designer forum or discussion group 174, for example. Use of dynamic stimuli according to the present invention also allows for use of various unplanned studies 176. With this structure, the event can respond creatively to unplanned input or to its own dynamic direction.

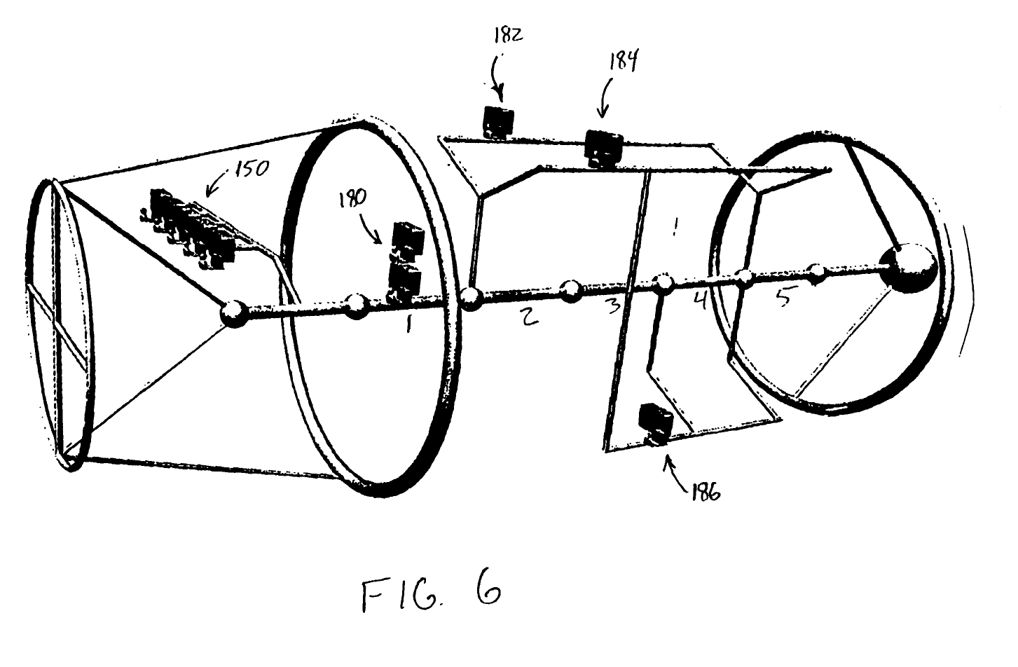

FIG. 6 illustrates one possible research event scenario in which deployable resources and dynamic stimuli are used according to the present invention. In the scenario illustrated in FIG. 6, a particular new product theme consistently emerges as a leader. Deployable resources 150 are used to present previously prepared stimuli to groups of respondents on day one. Based on feedback from the respondents throughout day one, one theme consistently emerges as superior relative to the other stimuli presented. As such, some of the resources 150 are redeployed from investigating the linear stimuli representing the main theme to other studies. For example, resources 180 may be used to continue the investigation of the main themes using the core stimuli while resources 182 and 184 are used to investigate product appearance via a funnel study (described with reference to FIG. 9) and a minor modifications study (described with reference to FIG. 11), respectively. Based on the results of the minor modifications study, resources 186 may then be used in a specific inquiry to search for “keys” to the success of the apparent leader. The identified “keys” may then be used to modify the core stimuli to verify the findings using all resources 150 on the last day or days of the event. As such, in this example, participant feedback is used to modify the linear stimuli and generate new stimuli for use in the parallel studies to deepen the inquiry and improve the overall value or quantity of research data obtained during the course of the event.

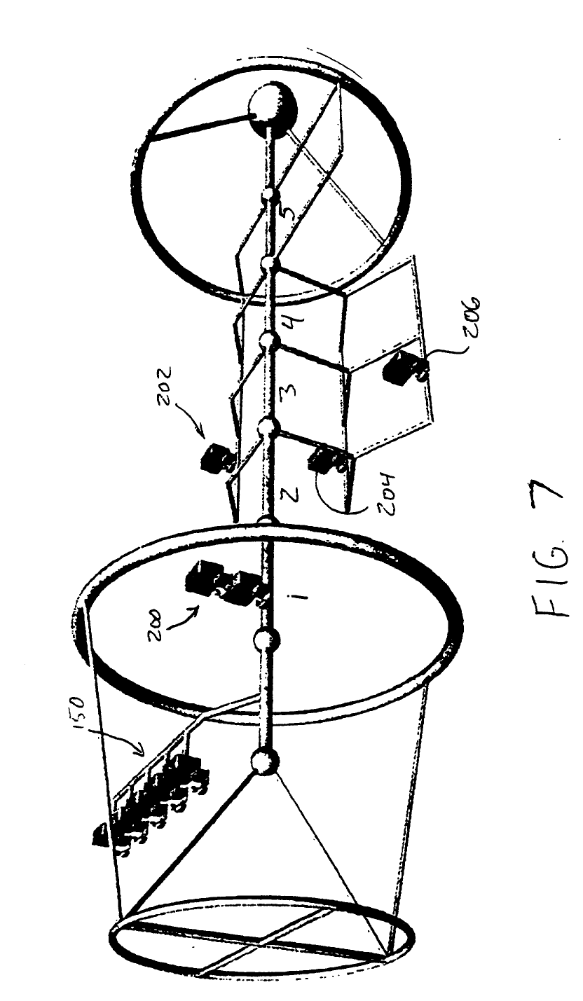

A second scenario for an interactive research event according to one embodiment of the present invention is graphically represented in FIG. 7. The research process model of FIG. 7 represents an event dynamic where no clear leader emerges. The event begins with all deployable resources 150 used to investigate the main themes using the core (linear) stimuli. After the second day, resources 202 are deployed on content studies while resources 204 and 206 are deployed on appearance studies to investigate alternative colors and materials, respectively. Feedback obtained from the parallel studies is used to modify the stimuli representing the main themes so that the parallel studies are not performed in isolation from the primary objective. The focused interactive study groups can be used to determine the best execution of a primary theme based on satellite stimuli approved by the design studio, brand, and customer with modified themes returned to the event to perpetuate and deepen the investigation or inquiry.

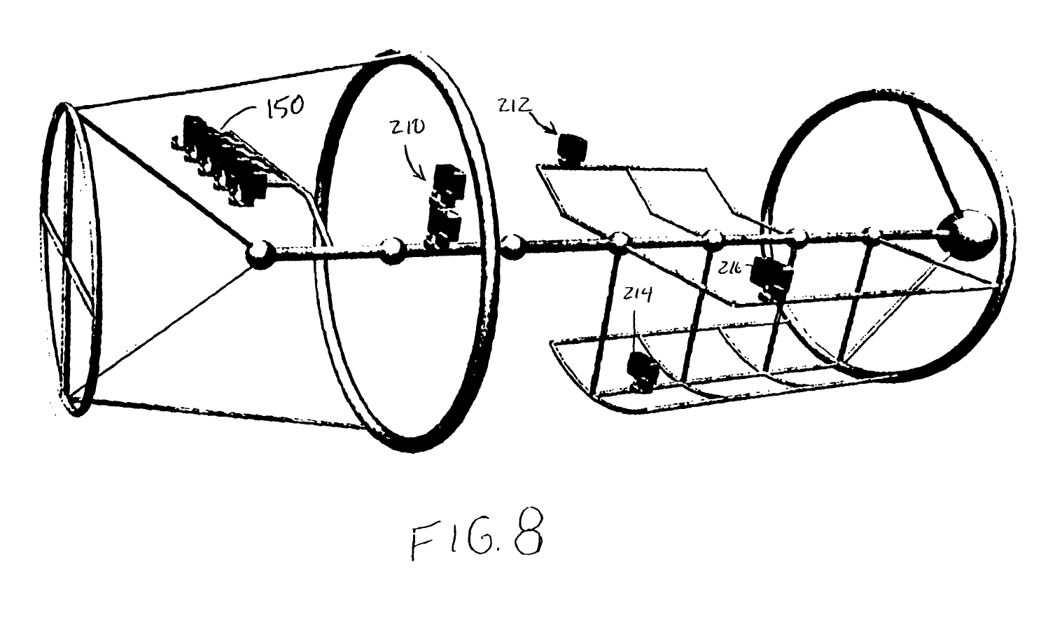

FIG. 8 provides a graphical representation of a third possible scenario for an interactive research event according to one embodiment of the present invention. The event dynamic depicted in FIG. 8 corresponds to a benchmark or competitive product emerging as a leader. In this scenario, resources 210 may continue to investigate the main themes represented by the core stimuli while resources 212 are deployed to investigate packaging issues via a relative value study (described with reference to FIGS. 10A-10C). Likewise, resources 216 may be deployed in a designer forum to provide a broader examination of the primary theme as represented by the core stimuli. Resources 214 may then be used to explore any unplanned product modifications based on feedback from the respondents.

While three different event dynamics and responses have been illustrated and described with reference to FIGS. 6-8, of course a virtually unlimited number of possible scenarios exist. The present invention provides the necessary flexibility to respond to the event dynamic with new or modified stimuli developed and presented using deployable resources to enhance the value of the data obtained during the event. This may reduce the number of events necessary to fully explore the multitude of design considerations in developing a product leading to a reduced time to market.

A graphical representation of a funnel study is provided in FIG. 9. A funnel study may be used to establish boundaries 240 for further internal development of a design concept 250 in developing a particular product 252. Boundaries 240 delineate research derived “danger” areas represented by reference numeral 242 that may impact the success of a particular theme or design concept 250. Boundaries 240 may be established based on negative feedback from participants in response to modifications to the primary design concept 250.

FIGS. 10A-10C provide graphical illustrations of a relative value study (RVS) that may be used to determine the relative importance of various product characteristics such as content 260, packaging 262, and satisfying customer needs 264, for example. When used in a system or method according to the present invention, a relative value study may begin with an assumption that all characteristics have equal weight in determining whether the product will be successful as illustrated in FIG. 10A and represented by previously prepared (original) digital stimuli. The digital stimuli are presented to one or more respondents or groups of participants with feedback used to modify the product characteristics as depicted in FIG. 10B. This process is repeated with additional modifications of the digital stimuli made to determine the relative importance of the product content 260, packaging 262, and functional aspects 264.

FIG. 11 provides a graphical representation of a minor modifications study. A minor modifications study may be conducted to fine tune a product based on respondent feedback. As shown in FIG. 11, a minor modifications study 270 may use a variety of satellite data 272 to make minor changes to the appearance or other theme as represented by area 274.

As such, the present invention provides a system and method for interactive product research that use multiple parallel studies to support a central research strategy using feedback from participants based on dynamic stimuli and redeployable resources in response to feedback from participants.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for conducting interactive market research during a research event having a plurality of participants, the method comprising:
presenting previously prepared stimuli to the participants of the research event;
collecting participant feedback to the previously prepared stimuli;
reviewing the participant feedback;
generating new stimuli based at least in part on the participant feedback;
presenting the new stimuli to the participants during the research event; and
collecting participant feedback to the new stimuli.

2. The method of claim 1 wherein the previously prepared stimuli and the new stimuli comprise computer generated graphics.

3. The method of claim 2 wherein the previously prepared stimuli and the new stimuli comprise surface renderings.

4. The method of claim 1 wherein the previously prepared stimuli and the new stimuli comprise high resolution interactive three-dimensional images developed from surface data.

5. The method of claim 1 wherein the previously prepared stimuli and the new stimuli comprise computer generated animations.

6. The method of claim 1 further comprising repeating the steps of generating new stimuli, presenting the new stimuli, and collecting participant feedback to the new stimuli during the research event.

7. The method of claim 1 further comprising:
storing the previously prepared stimuli, the new stimuli, and corresponding participant feedback in a remotely accessible database.

8. The method of claim 1 wherein the previously prepared stimuli include core stimuli and satellite stimuli and wherein the step of presenting the previously prepared stimuli comprises:
presenting the core stimuli to a first group of the plurality of participants; and
presenting the satellite stimuli to a second group of the plurality of participants in parallel with presenting the core stimuli to the first group.

9. The method of claim 1 wherein the previously prepared stimuli include core stimuli and satellite stimuli and wherein the step of presenting the previously prepared stimuli comprises:
presenting the core stimuli in combination with a first satellite stimulus to a first group of the plurality of participants; and
presenting the core stimuli in combination with a second satellite stimulus to a second group of the plurality of participants in parallel with presenting the core stimuli in combination with the first satellite stimulus to the first group.

10. The method of claim 1 wherein the step of generating new stimuli comprises modifying the previously prepared stimuli.

11. The method of claim 1 wherein the step of generating new stimuli comprises modifying the previously prepared stimuli in response to negative participant feedback to alter event dynamics that may otherwise influence subsequent participant feedback.

12. A method for performing market research, the method comprising:
preparing digital stimuli for presentation to a plurality of respondents during a research event, the digital stimuli including core stimuli and satellite stimuli in the form of high resolution computer generated three-dimensional images developed from surface data;
presenting the digital stimuli to the respondents during the research event;
obtaining feedback from the respondents relative to the digital stimuli;
modifying the digital stimuli based on the feedback;
presenting the modified digital stimuli to a first group of respondents while presenting different core and satellite stimuli to a second group of respondents;
obtaining feedback from the first and second groups of respondents; and
storing the digital stimuli and the modified digital stimuli with associated feedback in a common database.

13. The method of claim 12 wherein the satellite stimuli represent alternative appearances, concepts, and content of a designated product.

14. The method of claim 12 wherein the steps of modifying the digital stimuli and presenting the modified digital stimuli comprise presenting digital stimuli to determine relative values of product content and packaging.

15. The method of claim 12 wherein the steps of modifying the digital stimuli and presenting the modified digital stimuli comprise presenting digital stimuli to determine product features that may adversely impact product acceptance.

16. The method of claim 12 wherein the steps of presenting the digital stimuli and presenting the modified digital stimuli comprise presenting the digital stimuli and the modified digital stimuli to a focus group.

17. The method of claim 12 wherein the steps of presenting the digital stimuli and presenting the modified digital stimuli comprise presenting the digital stimuli and the modified digital stimuli to respondents via the internet.

18. A system for conducting market research, the system comprising:
a first computer for generating digital stimuli including high resolution three dimensional images of a product developed from surface data; and
a second computer in communication with the first computer and a display device, the second computer controlling presentation of the digital stimuli to a plurality of respondents and collecting feedback from the respondents for communication with the first computer, wherein the first computer generates modified digital stimuli in based on the feedback for subsequent presentation to the respondents via the second computer.

19. The system of claim 18 wherein the first and second computers are connected via the internet.

20. The system of claim 18 wherein the first computer generates digital stimuli including animations.
